(19) United States
(12) Patent Application Publication
(10) Pub. No.: US 2016/0251542 A1
(43) Pub. Date: Sep. 1, 2016

(54) AQUEOUS COATING COMPOSITION FOR APPLYING A TOPCOAT

(71) Applicant: BASF Coatings GmbH, Muenster (DE)

(72) Inventors: Frank JOEGE, Sendenhorst (DE); Nicole ROTH, Muenster (DE); Petra TOBOLL, Havixbeck (DE)

(73) Assignee: BASF Coatings GmbH, Muenster (DE)

(21) Appl. No.: 15/027,138

(22) PCT Filed: Sep. 4, 2014
(86) PCT No.: PCT/EP14/68870

§ 371 Date: Apr. 4, 2016

(30) Foreign Application Priority Data
Oct. 16, 2013 (EP) 13188838.0

(51) Int. Cl. C09D 175/16; B05D 3/00; C09D 161/28

(52) U.S. Cl. CPC C09D 175/16; C09D 161/28; B05D 3/007

(57) ABSTRACT

The present invention relates to a use of an aqueous coating composition for applying a topcoat to at least one side of a substrate metal surface coated at least with a primer coat, said aqueous coating composition comprising at least one binder (A) in dispersion or solution in water, at least one crosslinking agent (B), at least one second binder (C) in dispersion or solution in water, and optionally at least one pigment (D), the second binder (C) being a copolymer which is obtainable by copolymerization of ethylenically unsaturated monomers in the presence of at least one polyurethane resin having polymerizable carbon double bonds; to a process for coating a substrate metal surface coated at least with a primer coat, said process comprising at least one step of at least single-sidedly applying the aqueous coating composition as topcoat to the substrate metal surface coated at least with a primer coat; and also to a coated substrate obtainable by this process.

The present invention relates to a use of an aqueous coating composition for applying a topcoat to at least one side of a substrate metal surface coated at least with a primer coat, said aqueous coating composition comprising at least one binder (A) in dispersion or solution in water, at least one crosslinking agent (B), at least one second binder (C) in dispersion or solution in water, and optionally at least one pigment (D), the second binder (C) being a copolymer which is obtainable by copolymerization of ethylenically unsaturated monomers in the presence of at least one polyurethane resin having polymerizable carbon double bonds; to a process for coating a substrate metal surface coated at least with a primer coat, said process comprising at least one step of at least single-sidedly applying the aqueous coating composition as topcoat to the substrate metal surface coated at least with a primer coat; and also to a coated substrate obtainable by this process.

For the production of flat and thin-walled metallic components such as, for example, automobile components and bodywork components, but also corresponding components from the sector of equipment casings, façade sheeting, ceiling claddings, or window profiles, suitable metal sheets such as steel or aluminum sheets are shaped by means of conventional technologies such as punching and/or drilling. Larger metallic components may be assembled by welding together a number of individual parts. Commonly in use as raw material for producing such components are long metal strips, which are produced by rolling of the metal in question and which, for the purpose of storage and for greater ease of transport, are wound up to form rolls (“coils”).

The stated metallic components must commonly be protected against corrosion. In the automobile sector in particular, the corrosion prevention requirements are very high, especially since the manufacturers often offer a guarantee against rust penetration for many years.

This anticorrosion treatment may be carried out on the completed metallic component, such as an automobile body welded together, for example. Increasingly, however, the anticorrosion treatment is nowadays undertaken at an earlier point in time, namely on the actual metal strips used for producing these components, as part of the coil coating process.

Coil coating is the continuous, single- or double-sided coating of flat rolled metal strips, such as of steel or aluminum strips, for example, with usually liquid coating compositions at speeds of approximately 60 to 200 m/min. This coil coating normally takes place in roll application with counterrotating rolls. After the coil coating process has been carried out, the metal strips generally have a number of different paint coats, of which at least one is responsible for sufficient corrosion protection. Normally, after an optional cleaning step for the metal strip, a thin pretreatment coat is applied to the metal strip, a primer is applied to the pretreatment coat, and this is followed by the application of at least one further topcoat to the primer coat (2-step application). Alternatively, instead of the successive application of the pretreatment coat and of the primer, it is also possible for a total of only one primer coat to be applied, this coat representing a combination of a pretreatment coat and primer coat applied in the 2-step application, and then at least one topcoat is applied to said combined pretreatment coat and primer coat (1-step application). A coil coating process known from the prior art is disclosed in WO 2006/079628 A2, for example. Given that the (further) metal processing of the metal strips thus coated does not usually take place until after painting by means of the coil coating process, the coating materials employed for this purpose, especially topcoat materials, are required to exhibit very high mechanical stability and also, according to intended use, very high weather resistance and/or chemical resistance.

A disadvantage of the liquid coating compositions typically used in the coil coating process particularly for the application of at least one topcoat is the presence therein of organic solvents, more particularly the presence therein of volatile organic solvents. The presence of these organic solvents is necessary in order to prevent any incidence of pop marks, i.e., any incidence of bubbles—still closed or already burst—within the respective coat to be applied. Such pop marks may be brought about in the course of drying and/or baking of the respective coat, more particularly of the topcoat, as a result of excessively rapid evaporation of solvents or elimination products from the chemical crosslinking, and for this reason the respective coating compositions are typically admixed with volatile organic solvents, examples being long-chain alcohols such as dodecyl alcohol, long-chain glycols, aromatic compounds, or alkanes, in order to prevent popping.

There exists, however, a need for liquid coating compositions which can be used in a process such as the coil coating process, more particularly for production of the topcoat, which are more environmentally benign than compositions typically employed—that is, are substantially free of organic solvents, more particularly of volatile organic solvents—but are nevertheless suitable for preventing the incidence of pop marks.

It is an object of the present invention, therefore, to provide a liquid coating composition which is suitable in particular for producing a topcoat by the coil coating process and which, moreover, has a beneficial effect on corrosion prevention. More particularly it is an object of the present invention to provide a liquid coating composition of this kind which has advantages relative to conventional liquid coating compositions used in the coil coating process for producing a topcoat. More particularly, furthermore, it is an object of the present invention to provide a liquid coating composition of this kind which is environmentally more benign, more particularly being substantially free from organic solvents, than the compositions typically employed, but which nevertheless is equally suitable for preventing the incidence of surface defects such as, for example, formation of pop marks, especially when the desire is for topcoats having a dry film thickness of not more than 25 μm.

This object is achieved by a use of an aqueous coating composition for applying a topcoat to at least one side of a substrate metal surface coated at least with a primer coat, said aqueous coating composition comprising
(A) at least one binder in dispersion or solution in water,
(B) at least one crosslinking agent,
(C) at least one second binder in dispersion or solution in water, and
(D) optionally at least one pigment,
the second binder (C) being a copolymer which is obtainable by copolymerization of ethylenically unsaturated monomers in the presence of at least one polyurethane resin having polymerizable carbon double bonds.

A first aspect of the present invention, therefore, is a corresponding use.

The at least one-sided application of a topcoat takes place preferably in a coil coating process.

It has been surprisingly found that the aqueous coating composition used in accordance with the invention is suitable, especially in a coil coating process, for the at least one-sided application of a topcoat to a substrate metal surface coated at least with a primer coat, said substrate being, for example, a metal strip. It has further been surprisingly found that as a result of the specific constituents of the coating composition, more particularly as a result of the presence of the second binder (C), it is possible to prevent the incidence of surface defects within the applied coat, such as of pinholes or pop marks, for example, more particularly of pop marks. More particularly it has been surprisingly found that no such popping occurs although the coating composition used in accordance with the invention is an aqueous coating composition, in other words a composition of the kind which is substantially free from organic solvents which in conventional coating compositions are typically used in order to prevent the popping. It has been surprisingly found, moreover, that the aqueous coating composition used in accordance with the invention is notable, in particular as a result of the presence of the second binder (C), for good wet adhesive strength and for a beneficial effect on corrosion prevention. A further feature of the coating composition used in accordance with the invention is that it is aqueous and therefore more environmentally benign than conventional coating compositions comprising organic solvents. It has also been surprisingly observed that the aqueous coating composition used in accordance with the invention enables topcoats to be provided having the above-described advantageous properties, more particularly without popping, in dry film thicknesses of in particular up to a maximum of 25 μm, such as in a range from 10 to 25 μm, for example, more particularly in a coil coating process.

The terms “pop marks”, “pinholes”, “wet adhesive strength”, “leveling defects”, “coil coating”, and “coil coating materials” are known to the skilled person and defined for example in Römpp Lexikon, Lacke and Druckfarben, Georg Thieme Verlag 1998.

The aqueous coating composition used in accordance with the invention is preferably a topcoating composition.

The aqueous coating compositions used in accordance with the invention comprise water as liquid diluent.

The term “aqueous” in connection with the coating composition used in accordance with the invention refers preferably to those liquid coating compositions which as liquid diluents—that is, as liquid solvent and/or dispersion medium—comprise water as the main component. Optionally, however, the coating compositions used in accordance with the invention may comprise at least one organic solvent in small fractions. Examples of such organic solvents include heterocyclic, aliphatic or aromatic hydrocarbons, mono- or polyfunctional alcohols, ethers, esters, ketones, and amides, such as N-methylpyrrolidone, N-ethylpyrrolidone, dimethylformamide, toluene, xylene, butanol, ethyl glycol and butyl glycol, and also their acetates, butyl diglycol, diethylene glycol dimethyl ether, cyclohexanone, methyl ethyl ketone, methyl isobutyl ketone, acetone, isophorone, or mixtures thereof. The fraction of these organic solvents is preferably not more than 20.0 wt %, more preferably not more than 15.0 wt %, very preferably not more than 10.0 wt %, more particularly not more than 5.0 wt % or not more than 4.0 wt % or not more than 3.0 wt %, even more preferably not more than 2.5 wt % or not more than 2.0 wt % or not more than 1.5 wt %, most preferably not more than 1.0 wt % or not more than 0.5 wt %, based in each case on the total fraction of the liquid diluents—i.e., liquid solvents and/or dispersion media—present in the coating composition used in accordance with the invention. More particularly, however, there are no organic solvents in the coating composition used in accordance with the invention—that is, the coating composition used in accordance with the invention contains water as sole diluent. In this context, accordingly, the expression “substantially free from organic solvents” in connection with the coating composition used in accordance with the invention preferably means that the fraction of organic solvents therein is not more than 20.0 wt %, more preferably not more than 15.0 wt %, very preferably not more than 10.0 wt %, more particularly not more than 5.0 wt % or not more than 4.0 wt % or not more than 3.0 wt %, even more preferably not more than 2.5 wt % or not more than 2.0 wt % or not more than 1.5 wt %, most preferably not more than 1.0 wt % or not more than 0.5 wt %, based in each case on the total fraction of the liquid diluents—i.e., liquid solvents and/or dispersion media—present in the coating composition used in accordance with the invention. More particularly, however, there are no organic solvents in the coating composition used in accordance with the invention—that is, the coating composition used in accordance with the invention contains water as sole diluent.

The fractions in wt % of the components (A), (B), (C), and optionally (D) and/or (E) and also water, present in the coating composition used in accordance with the invention add up preferably to 100 wt %, based on the total weight of the coating composition.

The term “comprising” in the sense of the present invention, in connection for example with the coating composition used in accordance with the invention, has—in one preferred embodiment—the meaning of “consisting of”. In this case, with regard to the coating composition used in accordance with the invention, in this preferred embodiment, one or more of the further below-mentioned components present optionally in the coating composition used in accordance with the invention may be present in the coating composition, such as, for example—as well as components (A), (B), (C), and optionally (D)-component (E) as well, moreover. All of the components may each be present in their preferred embodiments, as stated above and below, in the coating composition used in accordance with the invention.

The coating composition used in accordance with the invention preferably has a solids fraction, i.e. a solids content, in the range from 5 to 80 wt % or in the range from 10 to 60 wt %, more preferably in the range from 15 to 55 wt %, very preferably in the range from 20 to 50 wt %, based on the total weight of the coating composition. The skilled person is aware of methods for determining the solids fraction or solids content, i.e., the nonvolatile fractions. This solids content is determined preferably in accordance with DIN EN ISO 3251 (date: Jun. 1, 2008).

### Binder (A)

The binder (A) used in the aqueous coating composition used in accordance with the invention is a binder in dispersion or solution in water.

All customary binders known to the skilled person are suitable here as binder component (A) of the aqueous coating composition of the invention. Such binders are known, for example, from BASF Handbuch Lackiertechnik, 2002, pages 28 to 127. The binder (A) is preferably different from the binder (C)—that is, the binder (A) is not a copolymer obtainable by copolymerization of ethylenically unsaturated monomers in the presence of at least one polyurethane resin having polymerizable carbon double bonds.

A binder in the sense of the present invention is preferably a polymeric compound, such as a polymeric resin, which is responsible for filming. Pigments and fillers, in particular, are not subsumed by the term “binder”. Crosslinking agents, more particularly crosslinking agents (B), are preferably not subsumed by the term “binder” in the sense of the present invention.

The binder (A) preferably has reactive functional groups which allow a crosslinking reaction. This binder (A) is a self-crosslinking or externally crosslinking binder, preferably an externally crosslinking binder. In order to allow a crosslinking reaction, therefore, the coating composition used in accordance with the invention further comprises at least one crosslinking agent (B) as well as the at least one binder (A).

The binder (A) present in the aqueous coating composition used in accordance with the invention (and also the second binder (C)) and the crosslinking agent (B) present are preferably thermally crosslinkable. The binder (A) and also the second binder (C) and the crosslinking agent (B) are preferably crosslinkable on heating to a substrate temperature above room temperature, i.e., at a substrate temperature of 18-23° C. The binder (A), the second binder (C), and the crosslinking agent (B) are preferably crosslinkable only at substrate temperatures≧80° C., more preferably ≧110° C., very preferably ≧130° C., and especially preferably ≧140° C. With particular advantage the binder (A), the second binder (C), and the crosslinking agent (B) are crosslinkable at a substrate temperature in the range from 100 to 275° C., more preferably at 125 to 275° C., very preferably at 150 to 275° C., crosslinkable especially preferably at 175 to 275° C., with more particular preference at 200 to 275° C., and most preferably at 225 to 275° C.

The coating composition used in accordance with the invention preferably comprises at least one binder (A) which has reactive functional groups which allow a crosslinking reaction preferably in combination with at least one crosslinking agent (B).

Any customary crosslinkable reactive functional group known to the skilled person is contemplated here as a crosslinkable reactive functional group.

The binder (A) preferably has reactive crosslinkable functional groups selected from the group consisting of primary amino groups, secondary amino groups, hydroxyl groups, thiol groups, carboxyl groups, epoxide groups, and groups which have at least one C═C double bond, such as, for example, groups which have at least one ethylenically unsaturated double bond, such as vinyl groups and/or (meth)acrylate groups. More particularly the binder (A) used in accordance with the invention has crosslinkable hydroxyl groups and/or crosslinkable carboxyl groups, most preferably crosslinkable hydroxyl groups.

The expression “(meth)acrylic” or “(meth)acrylate” in the sense of the present invention embraces in each case the definitions “methacrylic” and/or “acrylic”, and “methacrylate” and/or “acrylate”, respectively.

The binder (A) preferably has a fraction of crosslinkable reactive functional groups, more particularly hydroxyl groups, in the range from 0.25 wt % to 4.5 wt %, more preferably from 0.5 to 4.0 wt %, very preferably from 0.75 to 3.5 wt %, more particularly from 1.0 to 3.0 wt %, based in each case on the total weight of the solids fraction of the binder (A).

The binder (A), especially if it is based on at least one polyurethane resin, preferably has a nonvolatile fraction, i.e., a solids fraction, in the range from 30 to 60 wt %, more preferably in the range from 35 to 55 wt %, very preferably in the range from 40 to 50 wt %, most preferably in the range from 40 to 45 wt %, based in each case on the total weight of the binder (A). Methods for determining the solids fraction are known to the skilled person. The solids fraction is determined preferably in accordance with DIN EN ISO 3251 (date: Jun. 1, 2008).

The particulate solids in the binder (A) that make up the solids fraction preferably have an average particle size in the range from 10 to 150 nm, more preferably in the range from 15 to 125 nm, very preferably in the range from 20 to 100 nm, especially preferably in the range from 25 to 90 nm, most preferably in the range from 30 to 80 nm or in the range from 35 to 70 nm or in the range from 35 to 60 nm. Methods for determining the average particle size are known to the skilled person. The average particle size is determined preferably by means of laser correlation spectroscopy in accordance with DIN ISO 13321 (date: Oct. 1, 2004).

The binder (A) preferably has a weight-average molecular weight of 2000 to 200 000 g/mol, more preferably of 5000 to 150 000 g/mol, very preferably of 6000 to 100 000 g/mol, more particularly of 7000 to 80 000 g/mol or of 10 000 to 60 000 g/mol or of 12 000 to 40 000 g/mol or of 12 000 to 30 000 g/mol. The method for determining the weight-average molecular weight is described below.

The binder (A) preferably has a number-average molecular weight of 100 to 10 000 g/mol, more preferably of 200 to 5000 g/mol, very preferably of 250 to 2500 g/mol, more particularly of 300 to 1000 g/mol. The method for determining the number-average molecular weight is described below.

The binder (A) preferably has an acid number in the range from 2 to 50, more preferably from 3 to 45, very preferably from 4 to 40, especially preferably from 5 to 35 or from 5 to 30 or from 5 to 20 mg of KOH per g of binder (A). The skilled person is aware of methods for determining the acid number. The determination takes place preferably in accordance with DIN EN ISO 2114 (date: June 2002).

As binder (A) it is possible with preference to use at least one polymer selected from the group consisting of polyurethanes, polyesters, polyamides, polyureas, polystyrenes, polycarbonates, poly(meth)acrylates, epoxy resins, phenol-formaldehyde resins, melamine-formaldehyde resins, phenolic resins, and silicone resins, and also mixtures thereof, with preferably 70 to 100 wt % of the binder (A) present in the coating composition being selected from at least one of the aforementioned polymers, based in each case on the total weight of the solids content of the binder (A). Reference to the stated polymers is preferably in each case both to homopolymers and to copolymers. In one particularly preferred embodiment the binder (A) is selected from the group consisting of poly(meth)acrylates, polyurethanes, polyureas, and mixtures thereof, more particularly selected from the group consisting of polyurethanes, polyureas, and mixtures thereof, with preferably 70 to 100 wt % of the binder (A) present in the coating composition being selected from at least one of the aforementioned polymers, based in each case on the total weight of the solids content of the binder (A).

In one preferred embodiment the binder (A) used may be a binder which is cured with participation from isocyanate groups and/or oligomerized or polymerized isocyanate groups—very preferably, at least one such polyurethane and/or at least one such polyurea.

With particular preference the binder (A) used in the aqueous coating composition used in accordance with the invention is a binder in dispersion or solution in water that is based on at least one polyurethane resin. All customary binders known to the skilled person which are based on at least one polyurethane resin are suitable as binder component (A) of the aqueous coating composition used in accordance with the invention.

The preparation of polyurethane resins by a polyaddition reaction of at least one polyisocyanate—such as a diisocyanate, for example—with at least one polyol—such as a diol, for example—is known to the skilled person. Here, typically, a stoichiometric conversion of the OH groups of the polyols with the isocyanate groups of the polyisocyanates is required. However, the stoichiometric ratio to be used may also be varied, since the polyisocyanate may be added to the polyol component in amounts such that there may be an “overcrosslinking” or an “undercrosslinking”. Besides a reaction of NCO groups with OH groups (in the case of polyurethane binders) or with amino groups (in the case of polyurea binders), the di- and trimerization of isocyanates (to form uretdiones or isocyanurates), for example, may also occur, as a further reaction for the crosslinking.

As polyisocyanate component—such as, for example, as diisocyanate component—use is made preferably of (hetero)aliphatic, (hetero)cycloaliphatic, (hetero)-aromatic, or (hetero)aliphatic-(hetero)aromatic diisocyanates. Preferred diisocyanates are those containing to 36, more particularly 6 to 15, carbon atoms. Preferred examples are ethylene 1,2-diisocyanate, tetramethylene 1,4-diisocyanate, hexamethylene 1,6-diisocyanate (HDI), 2,2,4-(2,4,4)-trimethyl hexamethylene 1,6-diisocyanate (TMDI), diphenylmethane diisocyanate (MDI), 1,9-diisocyanato-5-methylnonane, 1,8-diisocyanato-2,4-dimethyloctane, dodecane 1,12-diisocyanate, ω,ω′-diisocyanatodipropyl ether, cyclobutene 1,3-diisocyanate, cyclohexane 1,3- and -1,4-diisocyanate, 3-isocyanatomethyl-3,5,5-trimethyl-cyclohexyl isocyanate (isophorone diisocyanate, IPDI), 1,4-diisocyanatomethyl-2,3,5,6-tetramethylcyclohexane, decahydro-8-methyl(1,4-methano-naphthalen-2(or 3),5-ylenedimethylene diisocyanate, hexahydro-4,7-methanoindan-1(or 2),5(or 6) ylenedimethylene diisocyanate, hexahydro-4,7-methanoindan-1(or 2),5(or 6) ylene diisocyanate, hexahydrotolylene 2,4- and/or 2,6-diisocyanate (H6-TDI), toluene 2,4- and/or 2,6-diisocyanate (TDI), perhydrodiphenylmethane 2,4′-diisocyanate, perhydrodiphenylmethane 4,4′-diisocyanate (H₁₂MDI), 4,4′-diisocyanato-3,3′,5,5′-tetramethyldi-cyclohexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetra-methylbenzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, naphthylene diisocyanate, 2,5(2,6)-bis(isocyanatomethyl)bicycle-[2.2.1]heptane (NBDI), and also any mixture of these compounds. Polyisocyanates of higher isocyanate functionality may also be used. Examples thereof are trimerized hexamethylene diisocyanate and trimerized isophorone diisocyanate. Furthermore, mixtures of polyisocyanates may also be utilized. Especially preferred are toluene 2,4-diisocyanate and/or toluene 2,6-diisocyanate (TDI), or isomer mixtures of toluene 2,4-diisocyanate and toluene 2,6-diisocyanate, and/or diphenylmethane diisocyanate (MDI) and/or hexamethylene 1,6-diisocyanate (HDI). Especially preferred is HDI as a polyisocyanate used for preparing the polyurethane resin.

As polyol component for preparing the binder (A) used in accordance with the invention and based on at least one polyurethane resin, preference is given to using polyester polyols and/or polyether polyols. Polyester polyols are particularly preferred. The binder (A) used in accordance with the invention and based on at least one polyurethane resin is preferably, therefore, a polyester-polyurethane resin. The binder (A) is therefore preferably prepared using a polyester polyol as prepolymer polyol component. Especially suitable as polyester polyols are those compounds which derive from at least one polyol such as at least one diol, as for example ethylene glycol, propylene glycol (1,2-propanediol), trimethylene glycol (1,3-propanediol), neopentyl glycol, 1,4-butanediol and/or 1,6-hexanediol, or such as at least one triol such as 1,1,1-trimethylolpropane (TMP), and from at least one dicarboxylic acid, as for example adipic acid, terephthalic acid, isophthalic acid, ortho-phthalic acid and/or dimethylolpropionic acid, and/or from at least one dicarboxylic acid derivative such as a dicarboxylic ester and/or a dicarboxylic anhydride such as phthalic anhydride.

Especially preferred is a polyester polyol of this kind, used as prepolymer polyol component, which derives from at least one diol and/or triol selected from the group consisting of 1,6-hexanediol, neopentyl glycol, trimethylolpropane, and mixtures thereof, and from at least one dicarboxylic acid (or at least one dicarboxylic acid derivative thereof) selected from the group consisting of adipic acid, terephthalic acid, isophthalic acid, ortho-phthalic acid, dimethylolpropionic acid, and mixtures thereof. Preferably at least one such polyester polyol is used with at least one polyisocyanate, more particularly with HDI, for preparing the polyurethane resin on which the binder (A) is based.

In order to permit a solution or dispersion of such a polyurethane resin in water, ionic and/or hydrophilic segments are typically incorporated into the polyurethane chain in order to stabilize the dispersion. Soft segments used may be preferably 20 to 100 mol % of high or low molecular mass diols such as, for example, dimethylolpropionic acid, based on the amount of all the polyols, preferably polyester polyols, having a number-average molecular weight Mₙ of 500 to 5000 g/mol, preferably of 1000 to 3000 g/mol. In this case firstly one prepolymer is prepared from at least one polyol such as at least one polyester polyol and from at least one polyisocyanate such as at least one diisocyanate, more particularly HDI, and this prepolymer—as a result of an excess of polyisocyanate used—has isocyanate groups as terminal reactive groups. In the second step these prepolymers are joined to one another via high or low molecular mass diols as chain extenders, such as dimethylolpropionic acid, for example, to form long-chain molecules, optionally in the presence of water. By way of such chain extenders it is possible to incorporate ionic groups into the polymer in order to stabilize it in the form of particles in dispersion in water. If, for example, dimethylolpropionic acid is used as chain extender, then a carboxyl functionality can be incorporated into the polymer, and can be deprotonated to allow the generation within the polymer of anionic segments.

Suitable polyurethane dispersions such as, for example, Bayhydrol® U2841XP from Bayer as binders (A) are available commercially.

If as binder (A) at least one polyurea is used, then suitable in particular as such a binder are polyurea-based resins which are prepared by a polyaddition reaction between compounds containing amino groups, such as polyamines, including diamines, and at least one isocyanate (including aromatic and aliphatic isocyanates, di-, tri- and/or polyisocyanates).

Where poly(meth)acrylate-based resins are used as binders (A), monomer mixtures or oligomer mixtures of esters are particularly suitable for preparing them, such as C₁₋₆ alkyl esters of acrylic acid and/or of methacrylic acid. The polymer is built up via the reaction of the C—C double bonds of these monomers. Poly(meth)acrylate-based resins of this kind may be cured by a radical polymerization, which is initiated, for example, by the decomposition of organic peroxides. Since this is a radical polymerization, there is no need for stoichiometric design of the poly(meth)acrylate-based resins and the crosslinking agent (B) that is to be used; in other words, (B) can be used in only small amounts, preferably catalytic amounts.

The aqueous coating composition used in accordance with the invention preferably comprises the binder (A) in an amount of 45 to 95 wt %, preferably in an amount of 50 to 90 wt %, more preferably in an amount of 55 to 85 wt %, based on the total weight of the binder (A) and of the crosslinking agent (B).

The aqueous coating composition used in accordance with the invention preferably comprises the binder (A) in an amount of 20 to 60 wt %, preferably in an amount of 25 to 55 wt %, more preferably in an amount of 30 to 50 wt %, based on the total weight of the aqueous coating composition.

The binder (A) is used preferably in the form of an aqueous solution or dispersion for preparing the aqueous coating composition used in accordance with the invention.

The binder (A) preferably has a nonvolatile fraction, i.e., a solids content, of 5 to 50 wt %, more preferably of 7.5 to 40 wt %, very preferably of 10 to 30 wt %, based in each case on the total weight of the aqueous coating composition.

### Crosslinking Agent (B)

The crosslinking agent (B) is suitable preferably for thermal crosslinking or curing. Crosslinking agents of this kind are known to the skilled person. To accelerate the crosslinking it is possible to add suitable catalysts to the aqueous coating composition.

All of the typical crosslinking agents (B) known to the skilled person may be used for preparing the aqueous coating composition used in accordance with the invention. Examples of suitable crosslinking agents are amino resins, resins or compounds containing anhydride groups, resins or compounds containing epoxide groups, tris(alkoxycarbonylamino)triazines, resins or compounds containing carbonate groups, blocked and/or nonblocked polyisocyanates, β-hydroxyalkylamides, and compounds having on average at least two groups capable of transesterification, examples being reaction products of malonic diesters and polyisocyanates or of esters and partial esters of polyhydric alcohols of malonic acid with monoisocyanates. Where blocked polyisocyanates are selected as crosslinking agents, the aqueous coating composition used in accordance with the invention is formulated as a 1-component composition (1-K). Where nonblocked polyisocyanates are selected as crosslinking agents, the aqueous coating composition is formulated as a 2-component composition (2-K).

One particularly preferred crosslinking agent (B) is selected from the group consisting of blocked polyisocyanates and melamine resins such as melamine-formaldehyde condensation products, more particularly etherified (alkylated) melamine-formaldehyde condensation products.

Utilized as blocked polyisocyanates may be any desired polyisocyanates such as, for example, diisocyanates in which the isocyanate groups have been reacted with a compound, so that the blocked polyisocyanate formed is stable especially with respect to reactive functional groups such as hydroxyl groups, for example, at room temperature, i.e., at a temperature of 18 to 23° C., but reacts at elevated temperatures, as for example at ≧80° C., more preferably ≧110° C., very preferably ≧130° C., and especially preferably ≧140° C. or at 90° C. to 300° C. or at 100 to 250° C., even more preferably at 125 to 250° C. and very preferably at 150 to 250° C. In the preparation of the blocked polyisocyanates it is possible to use any desired organic polyisocyanates suitable for the crosslinking, more particularly those already stated as a polyisocyanate component in connection with the preparation of the polyurethane resin on which the binder (A) of the coating composition used in accordance with the invention is based.

Likewise possible for use as suitable crosslinking agents (B) are melamine resins which can be dispersed or dissolved in water, preferably melamine-formaldehyde condensation products, more particularly optionally etherified (alkylated, as for example C₁-C₆ alkylated) melamine-formaldehyde condensation products. Their water-solubility or water-dispersibility is dependent—apart from on the degree of condensation, which is to be as low as possible—on the etherifying component, with only the lowest members of the alkanol or ethylene glycol monoether series giving rise to water-soluble condensates. Particularly preferred melamine resins are those etherified with at least one C₁₋₆ alcohol, preferably with at least one C₁₋₄ alcohol, more particularly with methanol (methylated), such as melamine-formaldehyde condensation products. Where solubilizers are used as optional further additives, it is also possible for ethanol-, propanol- and/or butanol-etherified melamine resins, more particularly the corresponding etherified melamine-formaldehyde condensation products, to be dispersed or dissolved in aqueous phase.

In one preferred embodiment the crosslinking agent (B) of the coating composition used in accordance with the invention is at least one melamine resin dispersible or soluble in water, preferably at least one melamine-formaldehyde condensation product dispersible or soluble in water, more particularly at least one etherified (alkylated), preferably methylated, melamine-formaldehyde condensation product dispersible or soluble in water.

The aqueous coating composition preferably comprises the crosslinking agent (B) in an amount of 5 to 35 wt %, preferably in an amount of 10 to 30 wt %, more preferably in an amount of 15 to 25 wt %, based on the total weight of the binder (A).

The aqueous coating composition preferably comprises the crosslinking agent (B) in an amount of 1 to 20 wt %, preferably in an amount of 2 to 15 wt %, more preferably in an amount of 3 to 10 wt %, based on the total weight of the aqueous coating composition.

### Binder (C)

The copolymer used as binder (C) is a copolymer obtainable by copolymerization of ethylenically unsaturated monomers in the presence of at least one polyurethane resin having polymerizable carbon double bonds. Copolymers which can be used as second binder (C) are known from WO 91/15528 A1 and may therefore be readily prepared by the skilled person.

The binder (C) used in the aqueous coating composition used in accordance with the invention is a binder in dispersion or solution in water.

The binder (C) preferably has a weight-average molecular weight of 2000 to 100 000 g/mol, more preferably of 5000 to 80 000 g/mol, very preferably of 15 000 to 60 000 g/mol, more particularly of 30 000 to 55 000 g/mol or of 35 000 to 50 000 g/mol. The method for determining the weight-average molecular weight is described below.

The binder (C) preferably has a number-average molecular weight of 100 to 50 000 g/mol, more preferably of 1000 to 40 000 g/mol, very preferably of 2500 to 25 000 g/mol, more particularly of 3000 to 20 000 g/mol, or from 4000 to 15 000. The method for determining the number-average molecular weight is described below.

The binder (C) preferably has an acid number in the range from 5 to 200, more preferably of 10 to 150, very preferably of 15 to 100, more particularly of 20 to 50 or from 25 to 40, mg of KOH per g of binder (C). The skilled person is aware of methods for determining the acid number. The determination takes place preferably in accordance with DIN EN ISO 2114 (date: June 2002).

The binder (C) preferably has an OH number (hydroxyl number) of 5 to 100, more preferably of 10 to 90, very preferably of 20 to 80, more particularly of 30 to 70 or of 40 to 60, mg of KOH per g of binder (C). The method for determining the hydroxyl number is described below.

The binder (C) is used preferably in the form of an aqueous solution or dispersion for preparing the aqueous coating composition used in accordance with the invention.

The binder (C) preferably has a nonvolatile fraction, i.e., a solids fraction, in the range from 25 to 65 wt %, more preferably in the range from 30 to 60 wt %, very preferably in the range from 35 to 55 wt %, most preferably in the range from 35 to 50 wt % or in the range from 35 to 45 wt %, based in each case on the total weight of the binder (C). Methods for determining the solids fraction are known to the skilled person. The solids fraction is determined preferably in accordance with DIN EN ISO 3251 (date: Jun. 1, 2008). The corresponding figures relate in each case to the binder (C) which is present in the form of an aqueous solution or dispersion and is used for preparing the aqueous coating composition.

The binder (C) preferably has a nonvolatile fraction, i.e., a solids content, of 5 to 50 wt %, more preferably of 5 to 40 wt %, very preferably of 7.5 to 30 wt %, more particularly of 7.5 to 20 wt %, based in each case on the total weight of the aqueous coating composition.

In another preferred embodiment the binder (C) has a nonvolatile fraction, i.e., a solids content, of 8.0 to 50 wt %, more preferably of 8.0 to 40 wt %, very preferably of 8.5 to 30 wt % or of 8.5 to 20 wt %, based in each case on the total weight of the aqueous coating composition.

The polyurethane resin having polymerizable carbon double bonds for preparing the binder (C) preferably has on average per molecule 0.05 to 1.1, preferably 0.2 to 0.9, more preferably 0.3 to 0.7 polymerizable carbon double bonds. It is preferred for the polyurethane resin used to have an acid number of 0 to 2 mg of KOH per g of polyurethane resin.

The at least one polyurethane resin having polymerizable carbon double bonds and used for preparing the binder (C) is preferably obtainable by reaction of at least one polyisocyanate with at least one polyol, more preferably with at least one polyester polyol.

As polyisocyanate components it is possible here to use the same aforementioned polyisocyanate components which are also used for preparing the polyurethane resin on which the binder (A) is based. Particular preference, however, is given to using isophorone diisocyanate (IPDI) as a polyisocyanate component for preparing the polyurethane resin on which the binder (C) is based.

As polyol components, more particularly polyester polyol components, it is possible here to use the same aforementioned polyol components, more particularly polyester polyol components, which are also used for preparing the polyurethane resin on which the binder (A) is based.

Used with more particular preference as at least one polyester polyol is a polyester polyol which derives from at least one diol and/or triol selected from the group consisting of 1,6-hexanediol, neopentyl glycol, trimethylolpropane, and mixtures thereof, more particularly 1,6-hexanediol and neopentyl glycol, and from at least one dicarboxylic acid (or at least one dicarboxylic acid derivative thereof) selected from the group consisting of adipic acid, terephthalic acid, isophthalic acid, ortho-phthalic acid, dimethylolpropionic acid, and mixtures thereof, more particularly adipic acid. Preference is given to using at least one such polyester polyol with at least one polyisocyanate, more particularly with IPDI, for preparing the polyurethane resin on which the binder (C) is based.

The at least one polyurethane resin used for preparing the binder (C) has polymerizable carbon double bonds as reactive functional groups which allow a crosslinking reaction. These reactive functional groups are preferably selected from the group consisting of vinyl groups such as allyl groups and (meth)acrylate groups and also mixtures thereof. Particularly preferred are vinyl groups such as allyl groups, more particularly allyl ether groups.

In order, when preparing the at least one polyurethane resin used for preparing the binder (C), to introduce polymerizable carbon double bonds as reactive functional groups into the polymer, the polyurethane resin is prepared using not only the at least one polyisocyanate and the at least one polyol—such as, for example, the at least one polyester polyol—but also at least one further polyol such as at least one diol as monomer, having at least one polymerizable carbon double bond as reactive functional group and additionally having at least one group that is reactive toward NCO groups—such as at least one hydroxyl group, for example. Preference is given to using at least one diol as monomer which additionally has at least one polymerizable carbon double bond as reactive functional group, more preferably a reactive functional group selected from the group consisting of vinyl groups such as allyl groups, allyl ether groups, and (meth)acrylate groups, and also mixtures thereof. Particularly preferred are vinyl groups, more particularly allyl ether groups. One such monomer used with preference is trimethylolpropane monoallyl ether. Alternatively it is possible as well to use at least one polyol selected from the group consisting of glycerol monoallyl ether, pentaerythritol monoallyl ether, and pentaerythritol diallyl ether, and mixtures thereof.

The polymerizable carbon double bonds present in the binder (C) are therefore preferably introduced into the polyurethane resin via choice of a suitable polyol component as monomer. At least one corresponding polymerizable carbon double bond is therefore already present in these monomers. With particular preference the polyurethane resin used for preparing the binder (C) has allyl ether groups as polymerizable carbon double bonds, which have been incorporated into the polyurethane resin preferably by choice of trimethylolpropane monoallyl ether as polyol component.

NCO groups still present in the resulting polyurethane segment may optionally be converted by reaction with at least one polyol such as trimethylolpropane until isocyanate groups are no longer detectable.

The polyurethane segment of the copolymer (C) may optionally be prepared by addition of at least one catalyst such as dibutyltin dilaurate. The polyurethane segment of the copolymer (C) is prepared preferably in an organic solvent such as methyl ethyl ketone (MEK), for example.

To prepare the copolymer (C), the resulting polyurethane resin, having at least one polymerizable carbon double bond, is copolymerized in the presence of ethylenically unsaturated monomers.

Monomers used as ethylenically unsaturated monomers for preparing the binder (C) are preferably selected from the group consisting of aliphatic and cycloaliphatic esters of acrylic acid or methacrylic acid ((meth)acrylates), ethylenically unsaturated monomers carrying at least one hydroxyl group in the molecule, preferably (meth)acrylates carrying at least one hydroxyl group in the molecule, ethylenically unsaturated monomers carrying at least one carboxyl group in the molecule, preferably (meth)acrylic acid, and mixtures thereof.

With particular preference the ethylenically unsaturated monomers are selected from the group consisting of cyclohexyl acrylate, cyclohexyl methacrylate, alkyl acrylates, and alkyl methacrylates having up to 20 carbon atoms in the alkyl radical, such as, for example, methyl (meth)acrylate, ethyl (meth)acrylate, n-propyl (meth)acrylate, isopropyl (meth)acrylate, n-butyl (meth)acrylate, tert-butyl (meth)acrylate, n-hexyl (meth)acrylate, ethylhexyl (meth)acrylate, stearyl (meth)acrylate and lauryl (meth)acrylate, or mixtures of these monomers, hydroxyalkyl esters of acrylic acid and/or methacrylic acid such as 2-hydroxyethyl (meth)acrylate, 2-hydroxypropyl (meth)acrylate, 3-hydroxypropyl (meth)acrylate, 3-hydroxybutyl (meth)acrylate, and 4-hydroxybutyl (meth)acrylate, (meth)acrylic acid, ethanediol di(meth)acrylate, 1,4-butanediol di(meth)acrylate, 1,6-hexanediol di(meth)acrylate, trimethylolpropane tri(meth)acrylate, pentaerythritol di(meth)acrylate, and allyl (meth)acrylate.

Ethylenically unsaturated monomers particularly preferred for preparing the binder (C) are selected from the group consisting of n-butyl (meth)acrylate, methyl (meth)acrylate, 2-hydroxypropyl (meth)acrylate, 3-hydroxypropyl (meth)acrylate, (meth)acrylic acid, and mixtures thereof.

The copolymerization may be initiated using at least one initiator such as, for example, tert-butyl peroxy-2-ethylhexanoate.

The copolymerization takes place preferably in an organic solvent such as methyl ethyl ketone (MEK), for example. The resulting copolymer (C) is preferably taken up in water and optionally neutralized with at least one neutralizing agent such as dimethylethanolamine. The organic solvent such as MEK, for example, is removed again after the copolymer (C) has been prepared, this removal being accomplished, for example, by vacuum distillation. The resulting dispersion may in this case retain a fraction of MEK used when preparing the copolymer (C), this fraction lying at most in a range from 0.2 to 1.5 wt %, preferably from 0.2 to 1.0 wt %, more preferably from 0.2 to 0.6 wt %, based in each case on the total weight of the dispersion.

### Coating Composition

The relative weight ratio of binder (C) to binder (A) in the coating composition is preferably in the range from 1:10 to 5:1, more preferably in the range from 1:8 to 4:1, very preferably in the range from 1:6 to 3:1, even more preferably in the range from 1:4 to 3:1, more particularly in the range from 1:3 to 1:1, most preferably in the range from 1:3 to 1:2, based in each case on the solids content of the binders (C) and (A). In another preferred embodiment the relative weight ratio of binder (C) to binder (A) in the coating composition is in the range from 1:10 to 1:1, more preferably in the range from 1:8 to 1:1, very preferably in the range from 1:6 to 1:1, even more preferably in the range from 1:4 to 1:1, more particularly in the range from 1:3 to 1:1, based in each case on the solids content of the binders (C) and (A). In a further preferred embodiment the relative weight ratio of binder (C) to binder (A) in the coating composition is in the range from 1:2.8 to 6:1, more preferably in the range from 1:2.8 to 4:1, very preferably in the range from 1:2.8 to 2:1, even more preferably in the range from 1:2.8 to 1:1, more particularly in the range from 1:2.5 to 1:1, based in each case on the solids content of the binders (C) and (A).

Other than the binders (A) and (C), the coating composition used in accordance with the invention preferably comprises no further binders.

### Pigment (D)

Depending on the desired application, the coating composition used in accordance with the invention may comprise at least one pigment (D). A pigment of this kind is preferably selected from the group consisting of organic and inorganic, coloring and extender pigments and also nanoparticles. Examples of suitable inorganic coloring pigments are white pigments such as zinc white, zinc sulfide, or lithopone; black pigments such as carbon black, iron manganese black, or spinel black; chromatic pigments such as chromium oxide, chromium oxide hydrate green, cobalt green, or ultramarine green, cobalt blue, ultramarine blue, or manganese blue, ultramarine violet or cobalt violet and manganese violet, red iron oxide, cadmium sulfoselenide, molybdate red or ultramarine red; brown iron oxide, mixed brown, spinel phases, and corundum phases, or chromium orange; or yellow iron oxide, nickel titanium yellow, chromium titanium yellow, cadmium sulfide, cadmium zinc sulfide, chromium yellow, or bismuth vanadate. Examples of suitable organic coloring pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black. Examples of suitable extender pigments or fillers are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers, or polymer powders; for further details, refer to Römpp Lexikon Lacke and Druckfarben, Georg Thieme Verlag, 1998, pages 250 ff., “Fillers”. Preferably the nanoparticles are selected from the group consisting of main-group and transition-group metals and compounds thereof. Preference is given to selecting the main-group and transition-group metals from metals of main groups three to five, of transition groups three to six, and of transition groups one and two of the Periodic Table of the Elements, and also the lanthanides. Particular preference is given to using boron, aluminum, gallium, silicon, germanium, tin, arsenic, antimony, silver, zinc, titanium, zirconium, hafnium, vanadium, niobium, tantalum, molybdenum, tungsten, and cerium, more particularly aluminum, silicon, silver, cerium, titanium, and zirconium. The compounds of the metals are preferably the oxides, oxide hydrates, sulfates, or phosphates. Preference is given to using silver, silicon dioxide, aluminum oxide, aluminum oxide hydrate, titanium dioxide, zirconium oxide, cerium oxide, and mixtures thereof; particular preference is given to using silver, cerium oxide, silicon dioxide, aluminum oxide hydrate, and mixtures thereof; very particular preference is given to using aluminum oxide hydrate, and more particularly boehmite. The nanoparticles preferably have a primary particle size<50 nm, more preferably 5 to 50 nm, more particularly 10 to 30 nm. Methods for determining the primary particle size are known to the skilled person. The primary particle size is determined preferably by means of transmission electron microscopy (TEM).

Particularly preferred are titanium dioxide and/or white pigments such as zinc white, zinc sulfide and/or lithopone as at least one pigment (D).

Effect pigments, furthermore, may be used as optional pigments (D) present in the aqueous coating composition. A skilled person is familiar with the concept of effect pigments. Effect pigments more particularly are those pigments which impart optical effect or color and optical effect, more particularly optical effect. A corresponding division of the pigments may be made in accordance with DIN 55944 (date: December 2011). The effect pigments are preferably selected from the group consisting of organic and inorganic optical effect and color and optical effect pigments. They are more preferably selected from the group consisting of organic and inorganic optical effect or color and optical effect pigments. The organic and inorganic optical effect and color and optical effect pigments are more particularly selected from the group consisting of optionally coated metallic effect pigments, of optionally coated metal oxide effect pigments, of effect pigments composed of optionally coated metals and nonmetals, and of optionally coated nonmetallic effect pigments. The optionally coated metallic effect pigments, such as silicate-coated metallic effect pigments, for example, are more particularly aluminum effect pigments, iron effect pigments, or copper effect pigments. Especially preferred are optionally coated—such as silicate-coated, for example—aluminum effect pigments, more particularly commercially available products from Eckart such as Stapa® Hydrolac, Stapa® Hydroxal, Stapa® Hydrolux, and Stapa® Hydrolan, most preferably Stapa® Hydrolux and Stapa® Hydrolan. The effect pigments used in accordance with the invention, more particularly optionally coated—such as silicate-coated, for example—aluminum effect pigments, may be present in any customary form known to the skilled person, such as a leaflet form and/or a platelet form, for example, more particularly a (corn)flake form or a silver dollar form. The effect pigments composed of metals and nonmetals are, more particularly, platelet-shaped aluminum pigments coated with iron oxide, of the kind described in, for example, European patent application EP 0 562 329 A2; glass leaflets coated with metals, more particularly aluminum; or interference pigments which comprise a reflector layer made of metal, more particularly aluminum, and which exhibit a strong color flop. The nonmetallic effect pigments are more particularly pearlescent pigments, especially mica pigments; platelet-shaped graphite pigments coated with metal oxides; interference pigments which comprise no metal reflector layer and have a strong color flop; platelet-shaped effect pigments based on iron oxide, having a shade from pink to brownish red; or organic liquid-crystalline effect pigments.

For further details of the effect pigments that are used in accordance with the invention, reference is made to Römpp Lexikon Lacke and Druckfarben, Georg Thieme Verlag, 1998, page 176, “Effect pigments”, and pages 380 and 381, “Metal oxide-mica pigments” to “Metal pigments”.

The amount of pigment (D) in the aqueous coating compositions used in accordance with the invention may vary very widely depending on intended use and on the nature of the pigments and nanoparticles. The pigment content, based on the aqueous coating compositions provided in accordance with the invention, is preferably in the range from 0.1 to 50 wt %, more preferably in the range from 1.0 to 45 wt %, very preferably in the range from 2.0 to 40 wt %, especially preferably in the range from 3.0 to 30 wt %, and more particularly in the range from 4.0 to 25 wt %.

### Further Additives (E)

Depending on the desired application, the coating composition used in accordance with the invention may comprise one or more typically employed additives as component (E). These additives (E) are preferably selected from the group consisting of antioxidants, antistats, wetting and dispersing agents, emulsifiers, flow control assistants, solubilizers, defoaming agents, wetting agents, stabilizers, preferably heat stabilizers and/or thermal stabilizers, process stabilizers, and UV and/or light stabilizers, photoprotectants, deaerators, inhibitors, catalysts, waxes, wetters and dispersants, flexibilizers, flame retardants, solvents, reactive diluents, vehicles, resins, hydrophobizing agents, hydrophilizing agents, carbon black, metal oxides and/or semimetal oxides, thickeners, thixotroping agents, impact tougheners, expandants, process aids, plasticizers, solids in powder and fiber forms, preferably solids in powder and fiber forms selected from the group consisting of fillers, glass fibers, and reinforcing agents, and mixtures of the abovementioned further additives. The amount of additive (E) in the coating composition of the invention may vary very widely according to intended use. The amount, based on the total weight of the coating composition used in accordance with the invention, is preferably 0.01 to 20.0 wt %, more preferably 0.05 to 18.0 wt %, very preferably 0.1 to 16.0 wt %, especially preferably 0.1 to 14.0 wt %, more particularly 0.1 to 12.0 wt %, and most preferably 0.1 to 10.0 wt %.

The present invention further relates to a method for producing the coating composition used in accordance with the invention.

The coating composition used in accordance with the invention may be prepared by mixing and dispersing and/or dissolving the respective components of the coating composition, as described above, in a water-based medium, using, for example, high-speed stirrers, stirring tanks, agitator mills, dissolvers, kneading devices, or inline dissolvers.

One aspect of the present invention is the use of the aqueous coating composition for at least single-sidedly applying a topcoat to a substrate metal surface coated at least with a primer coat, i.e., primed. The topcoat here is applied to the primed metal surface. This use takes place preferably in and/or by means of the coil coating process—that is, the coating of strips.

A further aspect of the present invention, moreover, is the use of the aqueous coating composition as a topcoat, preferably in and/or by means of the coil coating process—that is, the coating of strips.

The substrate used may be any object having at least one metallic surface.

The present invention relates more particularly to the use of the coating composition used in accordance with the invention for applying a topcoat to the metal surface of a metal strip, said surface having been coated at least one-sidedly at least with a primer coat. A preferred substrate used may therefore be a metal strip. This use occurs preferably as a process step in the coil coating process.

One preferred use is the use of the aqueous coating composition for applying a topcoat with a dry film thickness of up to 30 μm, more particularly up to 27 μm or up to 25 μm, such as, for example, a dry film thickness in the range from 10 to 27 μm or in the range from 10 to 25 μm, to a substrate metal surface coated at least one-sidedly at least with a primer coat. The coating composition used in accordance with the invention is applied preferably as topcoat in a dry film thickness in the range from 10 to 25 μm or from 10 to <28 μm or from 10 to <27 μm. With particular preference the coating composition used in accordance with the invention is applied as a topcoat in a dry film thickness in the range from 10 to 25 μm, very preferably in the range from 10 to 20 μm. The dry film thickness is determined by the method described below.

### Process

The present invention relates, moreover, to a process for coating a substrate metal surface coated at least with a primer coat, said process comprising at least the step of
(d) at least single-sidedly applying an aqueous coating composition as a topcoat to a substrate metal surface coated at least with a primer coat,
   said aqueous coating composition comprising
      (A) at least one binder in dispersion or solution in water,
      (B) at least one crosslinking agent,
      (C) at least one second binder in dispersion or solution in water, and
      (D) optionally at least one pigment,
      the second binder (C) being a copolymer which is obtainable by copolymerization of ethylenically unsaturated monomers in the presence of at least one polyurethane resin having polymerizable carbon double bonds.

All of the preferred embodiments described above herein in connection with the use of the aqueous coating composition, used in accordance with the invention, for at least single-sidedly applying a topcoat to a substrate metal surface coated at least with a primer coat, i.e., primed, are also preferred embodiments with regard to the use of the aqueous coating composition, used in accordance with the invention, in step (d) of the process of the invention, and to the process of the invention as such.

A further aspect of the present invention is a topcoat obtainable by the process of the invention, more particularly by step (d). This topcoat is applied to the primed metal surface. The process here is preferably a coil coating process, i.e., a process for coating strips.

The present invention relates more particularly to a process for applying a coating to at least one side of a substrate metal surface coated at least with a primer coat, such as the metal surface of a metal strip, further comprising the steps of
(a) optionally cleaning the substrate metal surface to remove soiling,
(b) optionally at least single-sidedly applying a pretreatment coat to at least one substrate metal surface,
(c) at least single-sidedly applying a primer coat to at least one substrate metal surface or, where appropriate, to the pretreatment coat at least single-sidedly applied in step (b), and optionally curing the applied primer coat,
(e) curing the at least single-sidedly applied topcoat,
(f) optionally applying one or more further coats to the cured topcoat.

Step (d) of the process of the invention takes place here preferably between steps (c) and (e).

The present invention further provides a process for coating a substrate metal surface, comprising the steps of
(a) optionally cleaning the substrate metal surface to remove soiling,
(b) optionally at least single-sidedly applying a pretreatment coat to at least one substrate metal surface,
(c) at least single-sidedly applying a primer coat to at least one substrate metal surface or, where appropriate, to the pretreatment coat at least single-sidedly applied in step (b), and optionally curing the applied primer coat,
(d) at least one-sidedly applying an aqueous coating composition as topcoat to a substrate metal surface coated at least with a primer coat,
said aqueous coating composition comprising
   (A) at least one binder in dispersion or solution in water,
   (B) at least one crosslinking agent,
   (C) at least one second binder in dispersion or solution in water, and
   (D) optionally at least one pigment,
   the second binder (C) being a copolymer which is obtainable by copolymerization of ethylenically unsaturated monomers in the presence of at least one polyurethane resin having polymerizable carbon double bonds,
   (e) curing the at least single-sidedly applied topcoat,
   (f) optionally applying one or more further coats to the cured topcoat.

The optional steps (a) and/or (b) and/or (c) are carried out before step (d). Step (e) and optionally (f) is carried out after step (d).

The cleaning in the optional step (a) of the process of the invention preferably comprises degreasing of the metal surface of the substrate such as of the metal strip, for example. In the course of this cleaning it is possible to remove soiling which has become attached in the course of storage, or to remove temporary anticorrosion oils by means of cleaning baths.

The pretreatment coat in the optional step (b) of the process of the invention is applied preferably with a dry film thickness in a range from 1 to 10 μm, more preferably in a range from 1 to 5 μm. Alternatively the pretreatment coat may also have a dry film thickness<1 μm, as for example in the range from <1 μm to 5 μm. Application of the pretreatment coat takes place preferably in a dipping or spraying process or by roll application. This coat is intended to increase the corrosion resistance and may also serve to improve the adhesion of subsequent coats to the metal surface. Known pretreatment baths include, for example, those containing Cr(VI), those containing Cr(III), and also chromate-free baths, such as, for example, those containing phosphate.

Step (b) may alternatively also take place with an aqueous pretreatment composition which comprises at least one water-soluble compound containing at least one Ti atom and/or at least one Zr atom, and comprising at least one water-soluble compound as a source of fluoride ions, containing at least one fluorine atom, or with an aqueous pretreatment composition which comprises a water-soluble compound obtainable by reaction of at least one water-soluble compound containing at least one Ti atom and/or at least one Zr atom with at least one water-soluble compound as a source of fluoride ions, containing at least one fluorine atom. The at least one Ti atom and/or the at least one Zr atom here preferably have/has the +4 oxidation state. By virtue of the components present in the aqueous pretreatment composition, and preferably also by virtue of the appropriately selected proportions thereof, the composition preferably comprises a fluoro complex such as, for example, a hexafluorometallate, i.e., more particularly hexa-fluorotitanate and/or at least one hexafluorozirconate. The overall concentration of the elements Ti and/or Zr in the pretreatment composition preferably is not below 2.5·10⁻⁴ mol/L but is not greater than 2.0·10⁻² mol/L. The preparation of such pretreatment compositions and their use in pretreatment is known from WO 2009/115504 A1, for example. The pretreatment composition preferably further comprises copper ions, preferably copper(II) ions, and also, optionally, one or more water-soluble and/or water-dispersible compounds comprising at least one metal ion selected from the group consisting of Ca, Mg, Al, B, Zn, Mn and W, and also mixtures thereof, preferably at least one aluminosilicate and in that case more particularly one which has an atomic ratio of Al to Si atoms of at least 1:3. The preparation of such pretreatment compositions and their use in pretreatment is likewise known from WO 2009/115504 A1. The aluminosilicates are present preferably in the form of nanoparticles, having an average particle size which is determinable by dynamic light scattering in the range from 1 to 100 nm. The average particle size of such nanoparticles which is determinable by dynamic light scattering, in the range from 1 to 100 nm, is determined here in accordance with DIN ISO 13321 (date: Oct. 1, 2004). The metal surface after step (b) preferably has a pretreatment coat. Alternatively step (b) may also take place with an aqueous sol-gel composition.

The primer coat, i.e., a layer of primer, is applied preferably in step (c) of the process of the invention in a dry film thickness in a range from 5 to 45 μm, more preferably in a range from 2 to 35 μm, more particularly in a range from 2 to 25 μm. This coat is typically applied in a roll application process. Primer coats of this kind are known from WO 2006/079628 A1, for example.

The topcoat in step (d) of the process of the invention is applied preferably with a dry film thickness of up to 30 μm, more particularly up to 25 μm, such as a dry film thickness in the range from 10 to 27 μm or 10 to 25 μm, for example, to a substrate metal surface coated at least one-sidedly at least with a primer coat. The coating composition of the invention as topcoat is applied preferably in a dry film thickness in the range from 10 to 25 μm or from 10 to <28 μm or from 10 to <27 μm, more particularly from 10 to 25 μm. With particular preference the coating composition of the invention is applied as topcoat in a dry film thickness in the range from 10 to 25 μm or from 10 to 20 μm, very preferably in the range from 12 to 25 μm, more particularly in the range from 15 to 25 μm. The dry film thickness is determined by the method described below. This coat is typically applied in a roll application process.

The curing in step (e) takes place preferably at temperatures above the room temperature, i.e., above 18-23° C., more preferably at temperatures≧80° C., even more preferably ≧110° C., very preferably ≧140° C., and especially preferably ≧170° C. Particularly advantageous is curing at 100 to 250° C., more preferably at 150 to 250° C., and very preferably at 200 to 250° C. Curing takes place preferably over a time of 5 to 300 s, more preferably 10 to 120 s, very preferably of 30 s to 60 s.

The skilled person knows the preferred curing conditions described to be employed fundamentally within the coil coating process, which is a conventional process. The process of the invention, accordingly, is preferably a coil coating process. The coil coating conditions described can also be reproduced, at least exemplarily, on the laboratory scale. For example, curing can be performed at corresponding temperatures and time durations in an oven. In that case, owing to the heat exchange when the oven door is opened, somewhat longer cure times ought to be employed, of—for example—10 to 350 s, more particularly 15 to 150 s, especially preferably 35 to 70 s.

The process of the invention is preferably a continuous process.

The process of the invention is preferably a coil coating process, which is known to the skilled person, from WO 2006/079628 A1, for example.

The term “metal strip” in the sense of the present invention refers preferably not only to strips consisting entirely of at least one metal but also to strips which are only coated with at least one metal, i.e., have at least one metallic surface, and themselves consist of different kinds of material, such as of polymers or composite materials. “Strips” in the sense of the present invention are preferably sheetlike elements having at least one metallic surface, more preferably selected from the group consisting of sheets, foils, and plates. The term “metal” preferably also encompasses alloys. In one preferred embodiment a “metal strip” in the sense of the present invention consists entirely of metals and/or alloys. The metals or alloys in question are preferably nonnoble metals or alloys which are typically employed as metallic materials of construction and which require protection against corrosion.

All customary metal strips known to the skilled person may be coated by means of the process of the invention. The metals used for producing the metal strips of the invention are preferably selected from the group consisting of iron, steel, zinc, zinc alloys, aluminum, and aluminum alloys. The metal may optionally have been galvanized, such as galvanized iron or galvanized steel, for example, such as electrolytically galvanized or hot-dip-galvanized steel. Zinc alloys or aluminum alloys and also their use for the coating of steel are known to the skilled person. The skilled person selects the nature and amount of alloying constituents in accordance with the desired end use. Typical constituents of zinc alloys include more particularly Al, Pb, Si, Mg, Sn, Cu, or Cd. Typical constituents of aluminum alloys include more particularly Mg, Mn, Si, Zn, Cr, Zr, Cu, or Ti. The term “zinc alloy” is also intended to include Al/Zn alloys in which Al and Zn are present in approximately equal amounts, and also Zn/Mg alloys in which Mg is present in an amount of 0.1 to 10 wt %, based on the total weight of the alloy. Steel coated with alloys of these kinds is available commercially. The steel itself may include the customary alloying components known to the skilled person.

In the coil coating process, metal strips with a thickness of preferably 0.2 to 2 mm and a width of up to 2 m are transported at a speed of up to 200 m/min through a coil coating line, in the course of which they are coated.

Typical apparatus in which the process of the invention can be implemented comprises a feed station, a strip store, a cleaning and pretreatment zone, in which the optional cleaning may take place and optional pretreatment coat may be applied, a first coating station for applying the primer coat, along with drying oven and downstream cooling zone, a second coating station for applying the topcoat, with drying oven, laminating station, and cooling, and a strip store and a winder (2-coat line). In the case of a 1-coat line, in contrast, optional cleaning and also the application of a pretreatment primer coat take place in a combined cleaning, pretreatment, and coating zone together with drying oven and downstream cooling zone. This is followed by a coating station for applying a topcoat, with drying oven, laminating station, and cooling, and by a strip store and a winder.

The present invention relates, furthermore, to a coated substrate obtainable by the process of the invention, such as the coil coating process of the invention, such as a coated metal strip.

Further provided by the present invention is a component, preferably a metallic component, produced from at least one such coated substrate such as a coated metal strip. Components of this kind may be, for example, bodywork and parts thereof for motor vehicles such as automobiles, trucks, motorcycles, and buses, and components of electrical household products or else components from the sector of instrument casings, façade claddings, ceiling sheeting, or window profiles.

### Methods of Determination

### 1. Determination of the Hydroxyl Number

The method for determining the hydroxyl number is based on DIN 53240-2 (date: November 2007). Determination of hydroxyl number is used to ascertain the amount of hydroxyl groups in a compound. A sample of a compound whose hydroxyl number is to be ascertained is reacted here with acetic anhydride in the presence of 4-dimethylaminopyridine (DMAP) as catalyst, and the hydroxyl groups of the compound are acetylated. For each hydroxyl group there is one molecule of acetic acid formed, whereas the subsequent hydrolysis of the excess acetic anhydride yields two molecules of acetic acid. The consumption of acetic acid is determined by titrimetry from the difference between the main value found, and a blank value, which is to be run in parallel.

A sample is weighed out to an accuracy of 0.1 mg, using an analytical balance, into a 150 mL glass beaker, and the sample vessel is subsequently given a magnetic stirring bar and placed into the sample changer of an automatic titrator featuring sample changer and dosing stations for the individual reagents and solvents (Metrohm Titrando 835 with integrated Karl-Fischer titration stand, from Metrohm). After the sample has been weighed out, the processing sequence is started on the automatic titrator. The following operations are run fully automatically, in the order given below:
Addition of 25 mL of THF and 25 mL of catalyst reagent to all sample vessels
Stirring of the samples for 5-15 minutes, depending on solubility
Addition of 10 mL of acetylation reagent to all sample vessels
13 minutes' waiting, stirring for 15 seconds, further 13 minutes' waiting
Addition of 20 mL of hydrolysis reagent (N,N-dimethylformamide (DMF) and deionized water (DI water) in a ratio of 4:1% by volume) to all sample vessels
7 minutes' waiting, 15 seconds' stirring (3 times in total)
Titration with 0.5 mol/L methanolic KOH

Endpoint recognition takes place potentiometrically. The electrode system used here is an electrode system consisting of a platinum titrode and reference electrode (silver/silver chloride with lithium chloride in ethanol).

The acetylating reagent is prepared by charging 500 mL of DMF to a 1000 mL measuring flask, adding 117 mL of acetic anhydride, and making up to the 1000 mL mark with DMF.

The catalyst reagent is prepared by dissolving 25 g of 4-dimethylaminopyridine (DMAP) in 2.5 L of DMF.

The hydroxyl number (OH number) in mg of KOH/g is calculated according to the following formula:

$$OH number = \frac{( {V}_{2} - {V}_{1} ) \cdot c \cdot 56.1}{m} + AN$$

V1=consumption of KOH in the main test in mL (main value)
V2 consumption of KOH in the blank test in mL (blank value)
c=concentration of potassium hydroxide solution, in mol/L
m=initial mass in g
AN=acid number in mg of KOH/g of sample

### 2. Determination of Number-Average and Weight-Average Molecular Weights

The number-average molecular weight (Mₙ) is determined by gel permeation chromatography (GPC). This method of determination is based on DIN 55672-1 (date: August 2007). This method can be used to determine not only the number-average molecular weight but also the weight-average molecular weight (M_{w}) and the polydispersity (ratio of weight-average molecular weight (M_{w}) to number-average molecular weight (Mₙ)).

Approximately 5 mg of a sample (based on the solids fraction) are dissolved using an analytical balance in 1.5 mL of mobile phase. The mobile phase used is tetrahydrofuran containing 1 mol/L of acetic acid. The sample solution is further admixed with 2 μl of ethylbenzene/mL of solution. Any insoluble fractions that may be present, such as pigments, for example, are removed by centrifusion or filtration.

The number-average molecular weight (Mₙ) is determined against polymethyl methacrylate standards of different molecular weights (PMMA standards). Before the beginning of each determination here, a calibration is run. This is done by injecting the PMMA standards (each with a concentration of 0.1 mg/mL in mobile phase (which additionally contains 2 μl ethylbenzene/mL)). The calibration plot (5th-order polynomial) is constructed from the PMMA standards with different molecular weights, by determining the respective retention time of the individual PMMA standards for the analysis series.

The instrument used is a complete system comprising GPC column, Agilent 1100 pump, autosampler and RI detector. The column used is the column set PSS 10e3/10e5/10e6 (300 mm×8 mm; particle size 5 μm).

The following settings are used here:

Injection volume 100 μl

### Temperature 35° C.

Flow rate 1.0 ml/min
Run time 40 min

Evaluation takes place using PSS analytical software. The concentration of the molecules eluted from the separating columns according to descending coil size is measured using a concentration-sensitive detector, more particularly a differential refractometer. The resulting sample chromatogram is then used, together with the calibration plot determined beforehand for the system, to calculate the relative molar mass distribution, the number-average molecular weight (Mₙ), the weight-average molecular weight (M_{w}), and the polydispersity factor M_{w}/Mₙ. The limits of analysis are specified individually for each sample. The calculated values for Mₙ and M_{w} represent “equivalent PMMA molecular weights”. The absolute molecular weights of the polymers may deviate from these values.

### 3. MEK Test Based on DIN EN 13523-11 (Date: September 2011)

The MEK test serves to determine the resistance of coating films to solvents (rub test).

A piece of cotton compress (Art. No. 1225221 from Römer Apotheke Rheinberg) is affixed with a rubber band to the head of an MEK hammer and then soaked with MEK. The hammer weighs 1200 g and has a handle with a placement area of 2.5 cm². The hammer is likewise filled with solvent, which runs continuously into the cotton compress. This guarantees that the compress is dripping wet throughout the test. A metal test sheet is rubbed once back and forth (=1 DR, one double rub) with the compress, this sheet being like the metal test sheets TB1, TB2, and TV2, used in the examples. The test distance here is 9.5 cm. 1 DR here is to be performed in 1 s. During this procedure, no additional force is exerted on the hammer. The top and bottom points of reversal at the edges of the metal test sheet are not evaluated. A count is made of the DRs needed in order to erode the entire coating film on the metal test sheet down to the substrate, and this value is reported. If such erosion is not achieved by the time a maximum of 300 DRs have been reached, the test is terminated after a maximum of 300 DRs.

### 4. Gloss Measurement at 60° Angle According to DIN EN 13523-2 (Date: October 2012)

The gloss measurement at 60° is used to determine the surface gloss of coated areas. Determination takes place using a MICRO TRI-GLOSS gloss meter from BYK. Prior to each measurement, the instrument is calibrated with the installed calibration standards. For the test, the angle setting of 60° is selected on the instrument. 5 measurements are conducted in the longitudinal direction (film-drawing direction or direction of application), by placing the instrument onto the surface in a planar fashion, and reading off the measurement value. From 5 measurement values, an average is calculated and is noted in the test records. Assessment is made by determination of the gloss value (GU) between 0 and 100.

### 5. Determination of the Shade According to DIN EN 13523-2 (Date: October 2012)

This method is used to determine the shade values of coating systems. A coated metal test sheet, such as, for example, the test sheet TB1, TB2, or TV2 used in the examples, is clamped into a Byk Mac colorimeter from Byk (CIELAB color system) and subjected to measurement using the Color Care Toolbox software. The shade values L*, a*, b*, C*, and h* are reported in the measurement records.

### 6. Determination of the Erichsen Scratch Hardness Based on DIN EN 13523-12 (Date: February 2005)

This test is used to determine the resistance presented by a coating of a metal test sheet to a scratch needle according to ISO 1518. The metal test sheet under investigation, such as, for example, the metal test sheet TB1, TB2, or TV2 used in the examples, is clamped into a scratch hardness tester from Sikkens (model 601) in such a way that the scratch is applied perpendicular to the knife-coating direction. The scratch needle is drawn over the metal sheet under different applied forces. A determination is made of the force (value in N) with which the coating film is not scratched right through.

### 7. Determination of Corrosion Resistance

The corrosion resistance of coatings is ascertained by determining the edge corrosion and scribe-mark corrosion in a neutral salt spray test (based on DIN EN 13523-8 (date: July 2010)).

The reverse and the top and bottom edges of a metal test sheet (8.5×13 cm) coated with a coating film, such as, for example, one of the metal test sheets TB1, TB2, or TV2 used in the examples, is taped off with TESA-film (#4204) tape and thus protected from corrosion. The long edges of the metal test sheet are cut freshly once from top to bottom (right-hand edge) and once from bottom to top (left-hand edge). In deviation from DIN EN 13523-8, the metal test sheet is not deformed. Centrally on the sheet, the coating film is damaged over a length of approximately 11 cm using a scratch needle (van Laar), this damage mark necessarily being at least 2 cm from the edges. After this, the neutral salt spray test is carried out, using a SL 2000 corrosion tester from Liebisch. The attacking medium in this case is an aqueous NaCl solution with a concentration by mass of 50-60 g/L, which is sprayed continuously onto the sheet. The testing temperature is 35° C. (+2° C.). After 360 hours+1008 hours, during which the substrate remains in the test chamber, the sheet is rinsed off with water and, after storage for 2-5 hours, is scratched with a blade. The extent of the sub-film creep/corrosion that has taken place is now ascertained by measurement. For this purpose, a stencil produced in-house is placed on to the edges and measurement takes place at each of 10 marked sites. The stencil is then shifted by 0.5 cm and a further 10 points are measured. The average is subsequently formed. The same method is then used to measure the scribe mark, and here it is necessary to ensure that the stencil is applied in such a way that the 0-line (the line on the stencil which marks the value of zero mm) lies on the scribe mark, followed by measurement of the 10 sites to the right and left of the scribe mark respectively. Here again, the measurement is repeated after shifting by 0.5 cm. To obtain the average, the sum total of the values obtained by measurement is divided by 40. The area subjected to measurement serves as a comparison yardstick for the sub-film corrosion creep.

### 8. Determination of the Bendability/Cracking (T-Bend) and the Adhesion (Tape) of Coatings According to DIN EN 13523-7 (Date: October 2012)

The test method is used to ascertain the bendability or cracking (T-bend) and the adhesion (tape) of substrates coated with coating materials, under a flexural load, at 20° C.

The coated metal test sheets under investigation—such as, for example, the metal test sheets TB1, TB2, or TV2 used in the examples—are cut into strips 3-5 cm wide and prebent by 135°, with the coated side facing outward, so that the bending shoulder lies in the rolling direction (i.e., counter to the film-drawing direction). After edge bending to 135°, a specified number of metal test sheets is inserted, each having the same sheet thickness prior to the compression of the test panels with the vise. The extent of the deformation is indicated by the T value. The notation here is as follows:

0 T: no metal sheet as interlayer
0.5 T: 1 metal sheet as interlayer
1.0 T: 2 sheets as interlayer
1.5 T: 3 sheets as interlayer
2.0 T: 4 sheets as interlayer
2.5 T: 5 sheets as interlayer
3.0 T: 6 sheets as interlayer

The radius of bending is altered until the smallest bend has been found at which cracks are no longer visible in the coating on the bending shoulder under a magnifier at 10-times magnification. The resulting value is then recorded as the T-bend.

A strip of TESA-film (#4104) tape is then rubbed firmly on, using the finger or a thin rod, over this bending shoulder, and peeled off suddenly. This strip is adhered to a sheet of paper (black in the case of pale-colored coating systems or white in the case of dark coating systems) and investigated with the magnifier, under a 100 W lamp, for residues of coating material. The bending radius is altered until the smallest bend has been found at which there are no longer any residues of coating material visible on the TESA tape imprint under the magnifier at 10-times magnification. This value is then recorded as tape.

### 9. Determination of Dry Film Thickness According to DIN EN ISO 2808 (Method 6B) (Date: May 2007)

The coated surface of a substrate coated with at least this coating material, such as one of the metal test sheets TB1, TB2, or TV2, for example, is first marked with a dark or black Edding marker, and then at this marked site it is inscribed at an oblique angle down to the substrate in a V-shape using a cutter (defined by the scratch needle). Using the scale (microscope) built into the PIG film-thickness measuring instrument from Byk Gardner, with a 3419 cutter (1 part-line=1 μm), the film thickness of the individual coating can be read off. For a film thickness>2 μm, the read-off error is ±10%.

### 10. Determination of Popping

The test method is used to determine popping and to assess flow defects on substrates coated with at least one coating material, such as, for example, one of the metal test sheets TB1, TB2, or TV2. It determines the dry film thickness above which popping is evident on the film surface. The dry film thickness is determined according to the method described above in Section 9. A substrate such as an OE HDG 5 galvanized steel panel is coated with a coating composition under test, and is baked under the desired baking conditions. Following determination of the dry film thickness in accordance with the method described in Section 9, the coated substrates under investigation, such as, for example, one of the metal test sheets TB1, TB2, or TV2, are inspected to ascertain the film thickness above which the respective coating surface exhibits popping marks. This dry film thickness is reported as the popping limit. The inspection here takes place, for example, at different angles under different light conditions.

The inventive and comparative examples below serve to elucidate the invention, but should not be interpreted as restricting it.

### 1. INVENTIVE EXAMPLES B1 AND B2

1.1 Two examples, B1 and B2, of an aqueous coating composition used in accordance with the invention are prepared by combining, in each case with stirring and mixing using a dissolver, the components stated in Table 1, in the order indicated therein.

TABLE 1

| | Fraction of respective | Fraction of respective |
|---|---|---|
| | component in B1 in | component in B2 in |
| | wt % (inventive), | wt % (inventive), |
| | based in each case on | based in each case on |
| | the total weight of | the total weight of |
| Components | coating composition B1 | coating composition B2 |
| Binder (A) | 45.13 wt % | 33.94 wt % |
| Defoamer | 0.32 wt % | 0.24 wt % |
| Crosslinking | 7.77 wt % | 5.53 wt % |
| agent (B) | | |
| Pigment | 43.69 wt % | 48.69 wt % |
| mixture P1 | | |
| Defoamer | 0.16 wt % | 0.12 wt % |
| Wax | — | 6.08 wt % |
| Matting agent | — | 2.70 wt % |
| Deionized water | 2.93 wt % | 2.70 wt % |

The binder (A) used is the Bayhydrol® U 2841 XP product available commercially from Bayer. The crosslinking agent (B) used is a methylated melamine-formaldehyde resin available commercially from BASF under the name Luwipal 066 LF. The wax used is a wax emulsion based on modified paraffin. The wax, defoamer, and matting agent additives used are products available commercially. The wax used is Aquacer® 539, the defoamer used is Byk-33, and the matting agent used is Deuteron PMH-C.

The pigment mixture P1 used to prepare each of aqueous coating compositions B1 and B2 contains the ingredients as follows, which are mixed with one another in a dissolver in accordance with the order indicated in Table 2, and subsequently ground on a bead mill until an energy input of 75 Wh/kg has been reached:

TABLE 2

| | Fraction of the |
|---|---|
| | respective component in |
| | the pigment mixture in |
| Components | wt %, based in each case |
| of pigment | on the total weight of |
| mixture P1 | the pigment mixture |
| Copolymer (C) | 43 wt % |
| 1-Propoxy-2- | 1.5 wt % |
| propanol | |
| Pigment | 50 wt % |
| Wetting and | 1.5 wt % |
| dispersing agent | |
| Deionized water | 4 wt % |

The copolymer component (C) employed in accordance with the invention and present in the pigment mixture P1 is prepared as described in WO 91/15528 A1, page 23, line 26 to page 24, line 25. This copolymer is used in the form of an aqueous dispersion with a solids fraction of 44 wt %, based on the total weight of the dispersion. This dispersion may receive a fraction of MEK, used in the preparation of the copolymer (C), which is at most in a range from 0.2 to 0.6 wt %, based on the total weight of the dispersion. The pigment used is TiO₂. The wetting and dispersing agent additive used is Disperbyk 184, a product available commercially from Byk.

1.2 An OE HDG 5 galvanized steel sheet from Chemetall is subjected to alkaline cleaning using the commercially available Gardoclean® 55160 product from Chemetall, and is subsequently pretreated with the commercially available Granodine® 1455T product from Henkel. Subsequently a primer coat is applied, using a commercially available primer (Coiltec® Universal P CF from BASF) to a metal sheet which has been cleaned and pretreated in this way, followed by drying in a drawer oven at a substrate temperature of 216° C. for a period of 47 s. The primer coat has a dry film thickness of 5 μm. The galvanized steel sheet, cleaned, pretreated, and given a primer coat as above, is referred to hereinafter as sheet T. Using a coating rod, the prepared coating composition B1 or B2 is in each case subsequently applied as topcoat to a thus-coated sheet T, which is then cured under exemplary coil coating conditions, namely at a substrate temperature of 243° C. in a drawer oven for a time of 64 s. The dry film thickness of the resulting topcoat is 20 μm in each case. The sheets TB1 and TB2 are obtained.

### 2. COMPARATIVE EXAMPLES V1 AND V2

2.1 One comparative example, V1, of an aqueous coating composition is prepared by combining, with stirring and mixing using a dissolver, the components stated in Table 3, in the order indicated therein.

TABLE 3

| | Fraction of respective |
|---|---|
| | component in V1 in |
| | wt %, based in each case |
| | on the total weight of |
| Components | coating composition V1 |
| Binder (A) | 45.13 wt % |
| Defoamer | 0.32 wt % |
| Crosslinking | 7.77 wt % |
| agent (B) | |
| Pigment | 43.69 wt % |
| mixture P2 | |
| Defoamer | 0.16 wt % |
| Deionized water | 2.93 wt % |

Binder (A), defoamer, and crosslinking agent (B) used are the same components also used for the preparation of B1 and B2, respectively.

The pigment mixture P2 used to prepare coating composition V1 contains the ingredients as follows, which are mixed with one another in a dissolver in accordance with the order indicated in Table 4, and subsequently ground on a bead mill until an energy input of 75 Wh/kg has been reached:

TABLE 4

| | Fraction of the |
|---|---|
| | respective component in |
| | the pigment mixture in |
| | wt %, based in each case |
| Components of | on the total weight of |
| pigment mixture P2 | the pigment mixture |
| Binder (A) | 43 wt % |
| 1-Propoxy-2- | 1.5 wt % |
| propanol | |
| Pigment | 50 wt % |
| Wetting and | 1.5 wt % |
| dispersing agent | |
| Deionized water | 4 wt % |

The pigment used is TiO₂. The wetting and dispersing agent additive used is Disperbyk 184, a product available commercially from Byk. The aqueous coating composition B1 therefore differs from the comparative composition V1 in that B1 comprises copolymer (C) as second binder, whereas in V1 only binder (A) is used, as sole binder component.

2.2 As comparative example V2, the commercially available POLYCERAM® Plus P topcoating composition from BASF Coatings is used. This is not an aqueous coating composition, but rather a conventional, solvent-based coating composition, comprising the following components present in Table 5 below:

TABLE 5

| | Fraction of the respective |
|---|---|
| | component in V2 in wt %, |
| | based in each case on |
| | the total weight of |
| Components | coating composition V2 |
| Polyester binder | 26.06 wt % |
| Additives (defoamer, | 2.28 wt % |
| wax, flow control | |
| assistant) | |
| Melamine- and urea- | 7.56 wt % |
| based crosslinking | |
| agent | |
| Inorganic solids | 26.77 wt % |
| (pigments, | |
| extenders, salts) | |
| Defoamer | 0.15 wt % |
| Organic solvents | 36.69 wt % |
| (alcohols, | |
| paraffins, | |
| aldehydes, | |
| aromatics, | |
| alkylamines, and | |
| alkyl acetates) | |
| Deionized water | 0.49 wt % |

2.3 The comparative compositions V1 and V2 are applied in the same way as described in Section 1.3, after alkaline cleaning, pretreatment, and primer coating of the OE HDG 5 steel sheet from Chemetall, to one thus-coated steel sheet T in each case, and then cured under exemplary coil coating conditions at a substrate temperature of 243° C. over a period of 64 s. The resulting metal sheets are TV1 and TV2. The dry film thickness of the resulting topcoat in the case of TV2 is 20 μm. For TV1 it was impossible to determine the dry film thickness, owing to surface defects and flow defects.

### 3. RESULTS OF SOME PERFORMANCE TESTS

The results for a number of performance tests used to investigate the examples TB2 and TV2 are set out in Table 6 below. Each of the individual parameters is determined here by the method indicated above.

For the metal sheet TV1 with a topcoating containing no copolymer (C) it was impossible to carry out these tests, since massive flow defects developed in the course of topcoat curing.

TABLE 6

| | metal sheet | metal sheet | metal sheet |
|---|---|---|---|
| | TB1 coated | TB2 coated | TV2 coated |
| | with B1 as | with B2 as | with V2 as |
| | topcoat | topcoat | topcoat |
| Popping | none | none | none |
| Flow defects | none | none | none |
| T-bend | 2.5 to 3.0 | 2.5 | 3.0 |
| Tape | 0.0 | 0.5 | 0.0 |
| MEK | >300 | >300 | >300 |
| Gloss at 60° | 65.9 | 41.4 | 40.1 |
| Scratch hardness | 8.2 | 30.0 | 28.75 |
| [N] | | | |
| Scratch corrosion | 0.5 | — | — |
| after 360 h | | | |
| neutral salt spray | | | |
| test [mm] | | | |
| Shade L* | — | 92.01 | 92.87 |
| (lightness) | | | |
| Shade a* | — | −1.60 | −1.56 |
| (+red; −green) | | | |
| Shade b* | — | −0.74 | −0.85 |
| (+yellow; −blue) | | | |
| Shade C* | — | 1.76 | 1.78 |
| (brilliance) | | | |
| Shade h* | 195.94 | 204.74 | 208.45 |

The entry “—” in Table 6 denotes that the respective test was not carried out for the particular metal sheet.

From the results in Table 6 it is evident in particular that when using the inventive coating composition, B1 or B2, as topcoat for a substrate T, it is possible to prevent the incidence of surface defects such as pop marks. While this is also observed for the comparative composition V2, it is nevertheless achieved therein only through the presence of the high fractions of low-volatility organic solvents present in the composition, something which is undesirable on environmental grounds.

1.-15. (canceled)

16. A coating process, comprising applying an aqueous coating composition to at least one side of a substrate metal surface coated at least with a primer coat, to obtain a topcoat,
wherein:
the aqueous coating composition comprises
(A) at least one binder in dispersion or solution in water,
(B) at least one crosslinking agent,
(C) at least one second binder in dispersion or solution in water, and
(D) optionally at least one pigment; and
the second binder (C) is a copolymer obtained by copolymerizing at least one ethylenically unsaturated monomer in the presence of at least one polyurethane resin having at least one polymerizable carbon double bond.

17. The process of claim 16, wherein a relative weight ratio of the binder (C) to the binder (A) ranges from 1:10 to 1:1, based on a solids content of the binders (C) and (A).

18. The process of claim 16, wherein the binder (A) has crosslinkable hydroxyl groups.

19. The process of claim 16, wherein the binder (A) is based on at least one polyurethane resin and has a solids fraction ranging from 35 to 55 wt %, based in each case on a total weight of the binder (A).

20. The process of claim 16, wherein the crosslinking agent (B) is at least one optionally alkylated melamine-formaldehyde condensation product.

21. The process of claim 16, comprising the crosslinking agent (B) in an amount of 10 to 30 wt %, based on a total weight of the binder (A).

22. The process of claim 16, wherein the at least one polyurethane resin comprises at least one allyl ether group as the polymerizable carbon double bond.

23. The process of claim 16, wherein the binder (C) has a weight-average molecular weight of 15 000 to 60 000 g/mol.

24. The process of claim 16, wherein the binder (C) has a solids fraction ranging from 35 to 55 wt %, based on a total weight of the binder (C).

25. The process of claim 16, comprising:
(a) optionally cleaning the substrate metal surface to remove soiling;
(b) optionally applying a pretreatment coat to at least one side of the substrate metal surface, to obtain the substrate metal surface coated with the pretreatment coat;
(c) applying a primer coat to at least one side of the substrate metal surface, or optionally to the pretreatment coat, and optionally curing applied primer coat;
(d) applying the aqueous coating composition to at least one side of the substrate metal surface coated at least with the primer coat;
(e) curing the applied topcoat; and
optionally applying one or more further coats to the cured topcoat.

26. A topcoat obtained by the process of claim 16.

27. A topcoat obtained by the process of claim 25.
